(19) United States
(12) Patent Application Publication
(10) Pub. No.: US 2008/0138510 A1
(43) Pub. Date: Jun. 12, 2008

(54) OPTICAL DISK MOLD AND METHOD OF FORMING THE SAME

(76) Inventor: Fung-Hsu Wu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/836,153

(22) Filed: Aug. 9, 2007

(30) Foreign Application Priority Data
Dec. 8, 2006 (TW) 095146175

(51) Int. Cl. B05D 3/10

(52) U.S. Cl. 427/135; 425/112

(57) ABSTRACT

An optical disk mold is provided. The optical disk mold includes a first mold plate, a second mold plate, and a stamper. A mold cavity having a disk-shape is included between the first mold plate and the second mold plate for manufacturing an optical disk. A heat-keeping surface layer formed by a spraying process is included on a surface of the second mold plate in the mold cavity, so that the optical disk mold has a better pattern-transferring ability, and the cycle time of producing the disk can be shortened. The stamper lies on the heat-keeping surface layer of the second mold plate. A microstructure pattern is included on a surface of the stamper, so as to transfer the microstructure pattern to the produced optical disk.

### BACKGROUND OF THE INVENTION

1. Field of the Invention

The present invention relates to optical disk molds, and more particularly, to an optical disk mold having a heat-keeping surface layer formed by a spraying process that improves pattern transfer of the optical disk mold, and shortens a cycle time for producing optical disks.

2. Description of the Prior Art

As optical storage technology and disk-burning technology mature, compact disks (CDs) and digital versatile disks (DVDs) are poised to replace traditional magnetic disks, audiotapes, and videotapes, and already dominate the market. Optical storage devices are characterized by large storage capacity, reliable data stability, and convenient portability, so they are one of the most popular storage devices available on the market. Accordingly, usage of various optical storage devices, such as compact disk read only memory (CD-ROM), compact disk digital audio (CD-DA), compact disk interactive (CD-I), compact disk recordable (CD-R), compact disk-rewritable (CD-RW), digital versatile disk recordable (DVD-R), and digital versatile disk-rewritable (DVD-RW), increases daily.

Please refer to FIG. 1. FIG. 1 is a diagram of a prior art digital versatile disk 10. As shown in FIG. 1, the digital versatile disk 10 includes two plastic substrates 11 and 18, which are both 120 millimeters (mm) in diameter and 0.6 mm thick. The plastic substrate 11 includes a substrate base 12, a reflective layer 14, and a metal film 16. First, a plastic material is turned into a transparent base by injection molding, thereby forming a recess 13 in the substrate base 12. Subsequently, the substrate base 12 is coated with the reflective layer 14, so that DVD-format signals can be written onto the digital versatile disk 10 through modulation of a laser signal. After drying, a sputtering process forms a metal film 16 on the substrate base 12. Finally, the plastic substrate 11 and the plastic substrate 18 are combined by means of a thermo-press adhering treatment or an adhesive, after which an exterior label is printed to complete the manufacture of the digital versatile disk 10.

Please refer to FIG. 2. FIG. 2 is a diagram of a prior art optical disk injection mold 20. As shown in FIG. 2, the optical disk injection mold 20 includes a core plate 22, a cavity plate 24, and a plurality of cooling lines 26. The shape of products fabricated by the optical disk injection mold 20 depends substantially upon the shape of a mold cavity 28, which is formed between the core plate 22 and the cavity plate 24. The mold cavity 28 is substantially symmetric around a symmetric axis 27 that is approximately the center axis of injected molten plastic. The optical disk injection mold 20 further includes a sprue 21 by which molten plastic material (also called “molten plastic” for short) flows into the mold cavity 28. Cooling lines 26 are provided in the core plate 22 and the cavity plate 24 respectively for keeping the optical disk injection mold 20 at a relatively low temperature, so as to reduce the temperature of the plastic material located in the mold cavity 28.

For some high-precision components, such as data access substrates of the optical disks, microstructure patterns are usually made on the surfaces thereof. To fabricate the component and its surface pattern simultaneously using injection molding technology, the optical disk injection mold 20 usually contains a stamper 23 positioned on the surface of the cavity plate 24 in the mold cavity 28. The surface of the stamper 23 comprises the microstructure pattern so as to transfer the microstructure pattern of the stamper 23 to the optical disk substrate during the injection molding process. Since the surface patterns needed for the high-precision components, such as optical disks, are very fine, the microstructure pattern of the stamper 23 is typically formed through a chemical etching process, or a lithography process and an electroforming process.

The above-mentioned injection molding technology for forming the optical storage device is a cyclical process. First, the core plate 22 and the cavity plate 24 are combined. The low-temperature mold 20 is subsequently filled with the high-temperature molten plastic, such as polycarbonate, through the sprue 21. In the meanwhile, pressure (typically termed “packing pressure”) is maintained to make the plastic materials contract during the filling process, which is also called a thermo-press molding process. After a period of cooling, the high-temperature molten plastic cools down, and gradually solidifies, after which steps, such as mold opening, ejection, and mold closing, are carried out.

As known to those skilled in the art, temperature change of partial of molten plastic, which is in contact with the mold, greatly affects quality of the product during the injection molding process. Please refer to FIG. 3. FIG. 3 is a graph illustrating temperature distribution curves of the molten plastic in the prior art optical disk injection mold, where the horizontal axis is the distance from the center axis and the vertical axis is the temperature of the molten plastic varying with time. The curves represent temperature distribution with time. Curve 1, curve 2, curve 3, curve 4, curve 5, and curve 6 show the temperature of the molten plastic after the molten plastic has been injected into the mold for 0.01 seconds, 0.055 seconds, 0.24 seconds, 0.55 seconds, 1.0 seconds, and 2.0 seconds, respectively. As shown in FIG. 3, after the molten plastic has been injected into the mold, which is at a relatively low temperature, parts of the molten plastic that are adjacent to the mold (that is, parts of the molten plastic at a distance of about 300 micrometers (μm) from the center axis) cool down quickly in the prior art. Afterward, heat in the molten plastic is transmitted toward the mold, and dissipates outward, so that all of the molten plastic can cool down gradually.

However, the above-described prior art has some shortcomings. When the temperature of the molten plastic which contacts the mold, (also referred to as “boundary temperature”) decreases too rapidly, a higher packing pressure must be applied to the injection molding process. It not only increases the operating cost, but also increases the difficulty of forming the molten plastic into the designed product shape.

In order to prevent the boundary temperature from decreasing over-fast, and thereby deforming the injection molding product, the traditional method changes the operation of the cooling system in the mold, increasing the initial temperature of the mold slightly, and thus reducing the initial temperature difference between the mold and the molten plastic. However, this increases the required cycle time of the injection molding process, and results in a disappointing yield of the injection molding apparatus.

### SUMMARY OF THE INVENTION

As a result, the primary object of the present invention is to provide an optical disk mold that has a heat-keeping surface layer formed by a thermal spraying process, so that the optical disk mold transfers patterns more effectively, and the cycle time of producing the optical disk can be reduced.

According to one preferred embodiment of the present invention, an optical disk mold is disclosed. The optical disk mold includes a first mold plate, a second mold plate and a stamper. The second mold plate is positioned corresponding to the first mold plate, and a mold cavity is included between the first mold plate and the second mold plate. A surface of the second mold plate includes a first heat-keeping surface layer in the mold cavity. The stamper lies between the first mold plate and the first heat-keeping surface layer, and a surface of the stamper including a microstructure pattern thereon

According to another preferred embodiment of the present invention, a method of forming an optical disk mold is disclosed. First, a first mold plate and a second mold plate are provided. A mold cavity is included between the first mold plate and the second mold plate, and the mold cavity has a disk-shape. Subsequently, a first spraying process is performed so as to form a first heat-keeping surface layer on a surface of the second mold plate in the mold cavity.

Since a heat-keeping surface layer formed by a spraying process is included in the optical disk mold of the present invention, and the heat-keeping surface layer is characterized by a low heat-conductivity, the heat-keeping surface layer can increase the contact temperature between the molten plastic and the mold in the beginning of injecting the molten plastic. Thus, the temperature of the molten plastic can decrease steadily and quickly after the mold cavity is filled, so that the optical disk mold can have a better pattern-transferring ability, and that the cycle time of producing the optical disk can be shortened.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a prior art digital versatile disk.

FIG. 2 is a diagram of a prior art optical disk injection mold.

FIG. 3 is a temperature distribution graph of molten plastic in the prior art optical disk injection mold.

FIGS. 4-7 are diagrams illustrating a method of forming an optical disk mold having a heat-keeping surface layer in accordance with the first preferred embodiment of the present invention.

FIG. 8 is a temperature distribution graph of molten plastic in the optical disk mold in accordance with the first preferred embodiment of the present invention.

FIG. 9 is a temperature change graph of the optical disk mold at 0.24 seconds in accordance with the first preferred embodiment of the present invention.

FIG. 10 is a temperature change graph of the optical disk mold at 0.55 seconds in accordance with the first preferred embodiment of the present invention.

FIG. 11 is a diagram illustrating an optical disk mold having a heat-keeping surface layer in accordance with the second preferred embodiment of the present invention.

FIG. 12 is a diagram illustrating an optical disk mold having two heat-keeping surface layers in accordance with the third preferred embodiment of the present invention.

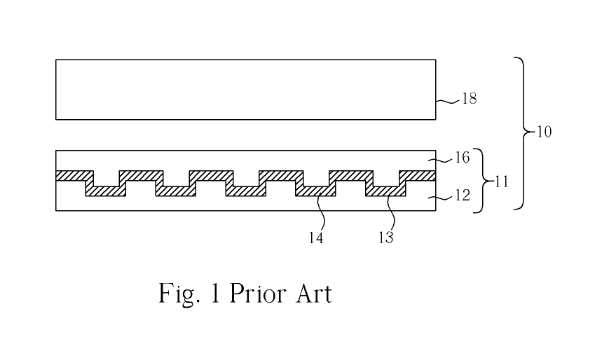

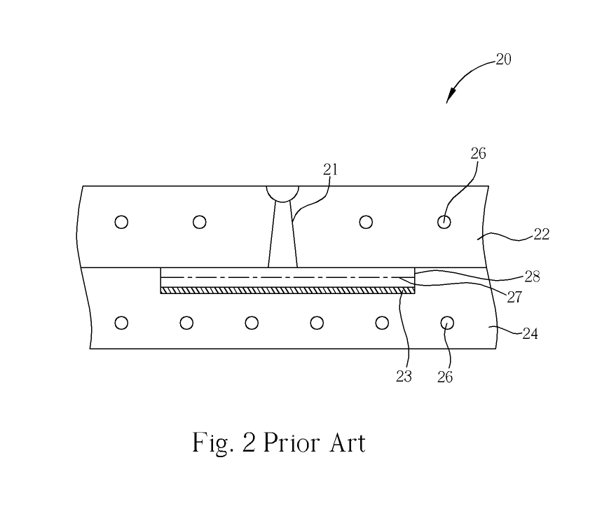

### DETAILED DESCRIPTION

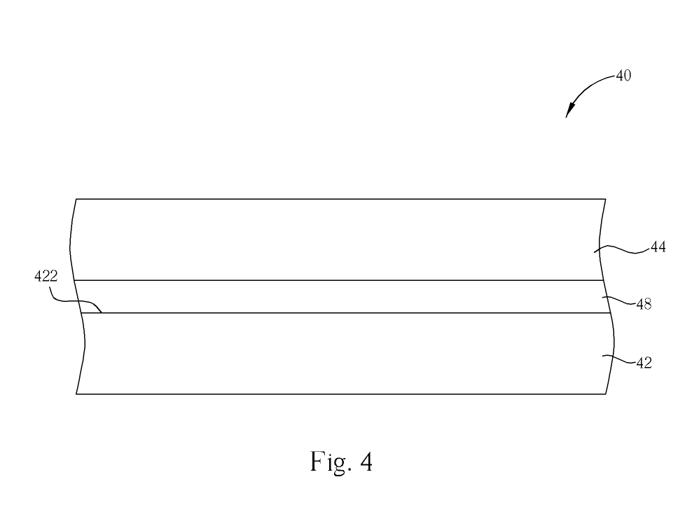

Please refer to FIGS. 4-7. FIGS. 4-7 are diagrams illustrating a method of forming an optical disk mold 40 having a heat-keeping surface layer 46 in accordance with the first preferred embodiment of the present invention, where like numbers designate parts, regions or elements similar to, or the same as, those of the prior art. It is worthy of note that the drawings are not drawn to scale and serve only for illustration purposes. In order to describe the embodiment briefly and to the point, a simplified optical disk mold 40 is shown in FIGS. 4-7 as an example. However, it should be noted that the optical disk mold 40 can contain further components, such as a rocket ring, a sprue bush, a return pin, a support, a knock-out pin, a sprue, a runner, and a gate. According to different configurations of the components, the optical disk mold 40 can be designed as a single-sprue mold, a three-plates mold, a plain mold, an automatic mold, a multi-cavity mold, and so on.

As shown in FIG. 4, a first mold plate 44 and a second mold plate 42 are provided. The second mold plate 42 undergoes some surface treatments, such as a polishing process, to adjust the shape and the thickness thereof, and subsequently undergoes a surface-roughing treatment and cleaning to turn a surface region of the second mold plate 42 adjacent to the mold cavity 48 into a cleaned rough surface 422. The first mold plate 44 is located above the second mold plate 42, and a mold cavity 48 is therefore formed between the two mold plates 42 and 44. Similar to the mold shown in the prior art, the optical disk mold 40 can further include at least a sprue (not shown in the figure) and at least a cooling system (not shown in the figure). The sprue is used for directing the molten plastic to flow into the mold cavity 48, and the cooling system keeps the optical disk mold 40 at a relatively low temperature, so as to decrease the temperature of the molten plastic in the mold cavity 48. The first mold plate 44 and the second mold plate 42 are usually made from strong materials with good heat conductivity, such as steel.

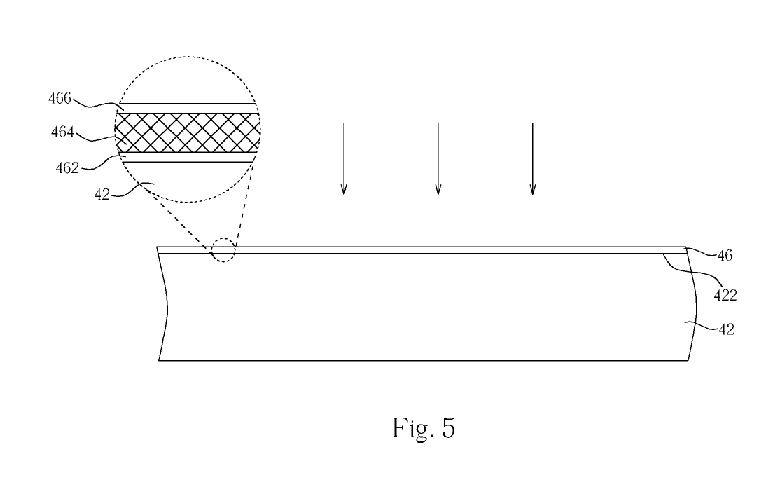

Furthermore, as shown in FIG. 5, a hot-spraying plating process is performed to form a connecting coating layer 462, a heat-insulating coating layer 464, and a first smooth coating layer 466 on the rough surface 422 of the second mold plate 42. The connecting coating layer 462 can be formed of ceramic materials or metal materials, such as zirconium oxide or aluminum-nickel alloy, that bind the rough surface 422 of the second mold plate 42 with the first heat-keeping surface layer 46 firmly and tightly, and have a thickness of about 50 μm. The heat-insulating coating layer 464 can include some heat-insulating materials, which have a lower heat-conducting coefficient than the optical disk mold 40. For instance, ceramic materials, such as aluminum oxide, zirconium oxide, or yttrium oxide can be applied to the heat-insulating coating layer 464. In addition, the thickness of the heat-insulating coating layer 464 is approximately in a range from 100 μm to 1000 μm, and preferably in a range from 150 μm to 250 μm. Furthermore, the first smooth coating layer 466 can be made from a fine material, such as tungsten carbide or aluminum silicide, and has a thickness of about 50 μm. Detailed structure, and the thickness of the first heat-keeping surface layer 46 are not limited to this embodiment of the present invention, and can be adjusted according to the actual design of the optical disk mold 40. After the first smooth coating layer 466 is sprayed, a polishing process can be carried out optionally on the first smooth coating layer 466 to even and smooth the surface of the first heat-keeping surface layer 46.

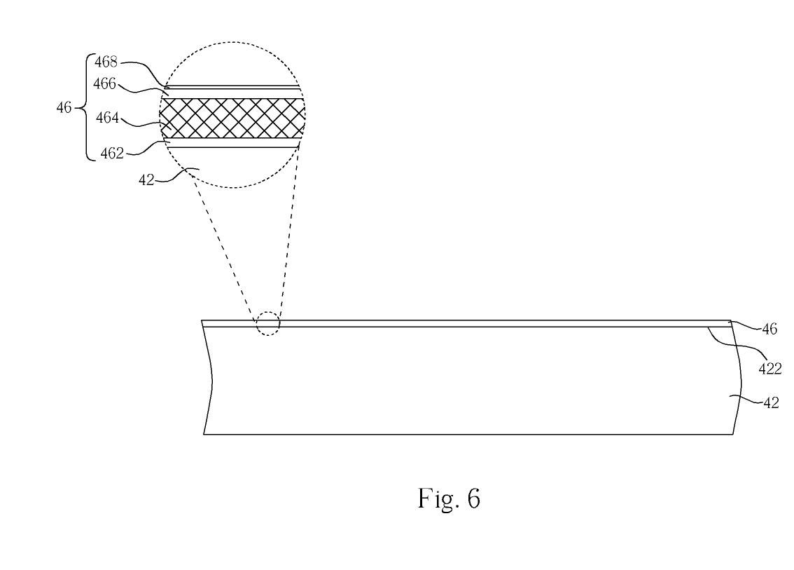

As shown in FIG. 6, a chemical mechanical polishing (CMP) process, or another plating process, can then be performed to form a second smooth coating layer 468 on the surface of the first smooth coating layer 466. The second smooth coating layer 468 can be made from finer materials, such as a diamond-like carbon coating (DLC) or titanium nitride (TiN), and has a thickness of about 2 μm. In the preferred embodiment, the connecting coating layer 462, the heat-insulating coating layer 464, and the first smooth coating layer 466 are all formed by means of hot-spraying processes. However, formation of the second smooth coating layer 468 is not limited to the hot-spraying process.

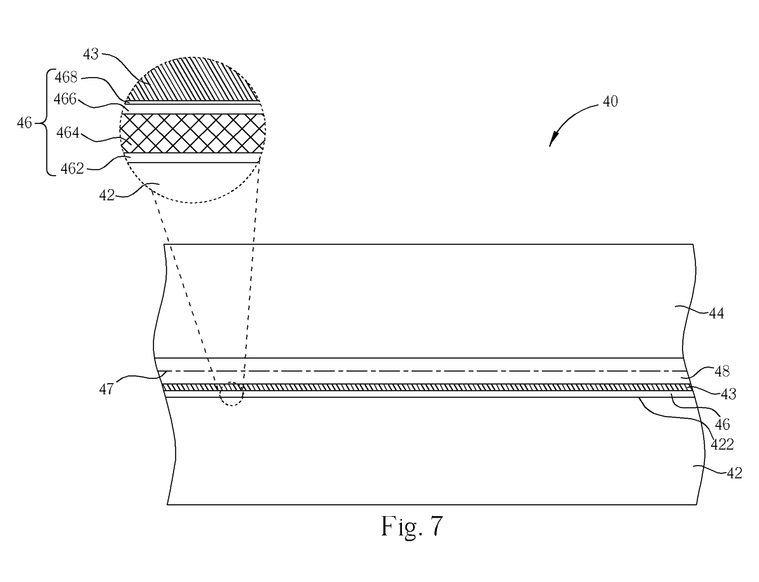

Next, as shown in FIG. 7, a stamper 43 is provided. The stamper 43 is positioned on the side of the second mold plate 42 or on the side of the first mold plate 44 in the mold cavity 48, and the optical disk mold 40 is therefore fabricated. In this embodiment, the stamper 43 is placed on the first heat-keeping surface layer 46 of the second mold plate 42, and the surface of the stamper 43 has a microstructure pattern (not shown in the figure). The microstructure pattern is usually formed by a chemical etching process, or through a lithography process and an electroforming process, and is used to fabricate an optical disk having the microstructure pattern. The stamper 43 can be fixed to the second mold plate 42 by means of inlaying or adhering, or it can be formed directly on the second mold plate 42. Since the shape formed by the optical disk mold 40 substantially depends on the shape of the mold cavity 48, the mold cavity 48 of the present invention should be disk-shaped. The mold cavity 48 is substantially symmetric to a symmetric axis 47 that is approximately the center axis of the injected molten plastic.

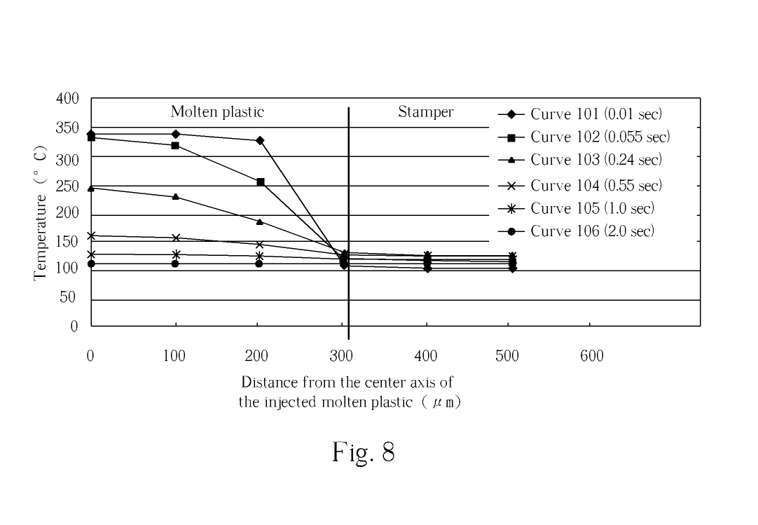

The temperature change of part of molten plastic in contact with the optical disk mold 40 greatly affects the quality of the product during the injection molding process. Please refer to FIGS. 8-10, which illustrate temperature change conditions of the mold. The chart data shown in FIGS. 8-10 are obtained from simulating and analyzing the mold coating layers by the finite element software ANSYS®. The analysis is conducted under operating conditions, where the heat-conducting coefficient of the molten plastic is 0.204 watts per meter per degree centigrade (W/m° C.), the density of the molten plastic is 1194.8 kilograms per cubic meter (kg/m³), the specific heat of the molten plastic is 1384 joules per kilogram per degree centigrade (J/kg° C.), the heat-conducting coefficient of the mold 40 is 20 W/m° C., the density of the mold 40 is 7740 kg/m³, the specific heat of the mold 40 is 460 J/kg° C., the heat-conducting coefficient of the stamper 43 is 10.9 W/m° C., the density of the stamper 43 is 8080 kg/m³, the specific heat of the stamper 43 is 462 J/kg° C., the heat-conducting coefficient of the ceramic materials is 1.8 W/m° C., the density of the ceramic materials is 6000 kg/m³, the specific heat of the ceramic materials is 400 J/kg° C., the initial temperatures of the first mold plate 44 and the second mold plate 42 approach 107° C., and the initial temperature of the molten plastic approaches 340° C.

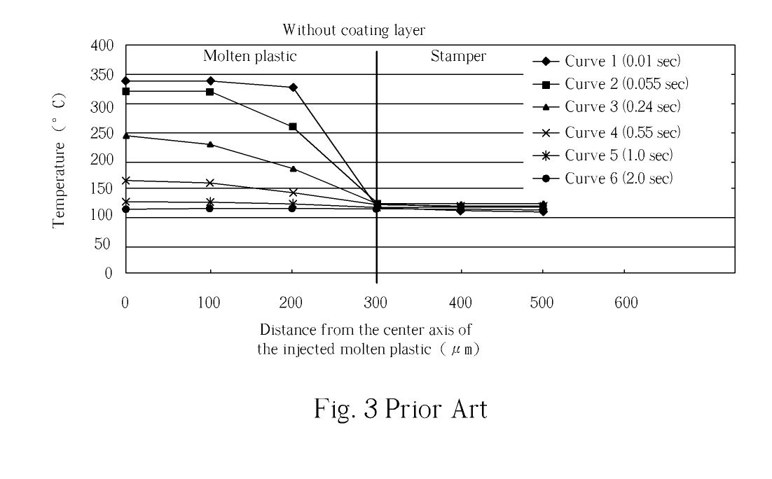

FIG. 8 is a graph illustrating the temperature distribution curves of the molten plastic in the optical disk mold 40 in accordance with the first preferred embodiment of the present invention, where the horizontal coordinate is the distance from the center axis and the vertical coordinate is the temperature of the molten plastic varying with time. The curves represent the temperature distribution varying with time. Curve 101, curve 102, curve 103, curve 104, curve 105 and curve 106 represent the temperatures of the molten plastic after the molten plastic has been injected into the mold for 0.01 seconds, 0.055 seconds, 0.24 seconds, 0.55 seconds, 1.0 seconds and 2.0 seconds, respectively. As shown in FIG. 8, at 0.01 seconds, when the molten plastic just contacts the optical disk mold 40, part of the molten plastic adjacent to the relatively cold optical disk mold 40, i.e. the part of molten plastic 300 μm from the center axis of the molten plastic, drops in temperature. From 0.01 seconds to 0.055 seconds, heat contained in the molten plastic raises the temperature of the partial molten plastic adjacent to the optical disk mold 40 (the molten plastic being apart from the center axis of the molten plastic for 300 μm). After 0.055 seconds, the heat contained in the molten plastic is transmitted toward the optical disk mold 40, and dissipates outward gradually, so that all parts of the molten plastic, i.e. the molten plastic at 0 μm to 300 μm from the center axis, can cool down steadily, and the whole molten plastic can drop in temperature and solidify bit-by-bit. Compared with FIG. 3, the optical disk mold 40 having the first heat-keeping surface layer 46 indeed increases the temperature of the molten plastic that is in contact with the optical disk mold 40 in the present invention, and makes the temperature of the molten plastic decrease steadily and quickly after the mold cavity 48 is filled. Since the over-fast decrease of the boundary temperature is prevented, a lower initial temperature of the optical disk mold 40 can be set by adjusting the cooling system. Accordingly, when the optical disk mold 40 having the first heat-keeping surface layer 46 is utilized, the following steps, such as mold opening, ejecting, and mold closing, can be carried out more speedily. As a result, the pattern-transfer ability of the optical disk mold 40 can be increased, and the cycle time of producing the optical disk can be shortened.

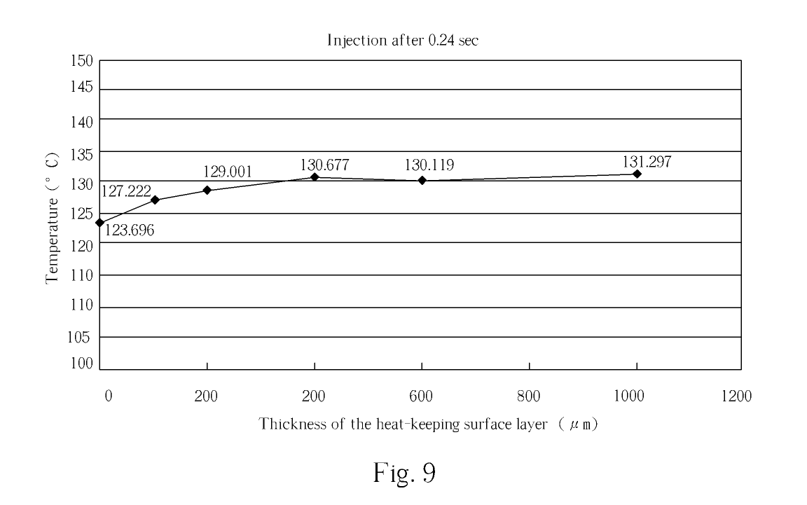

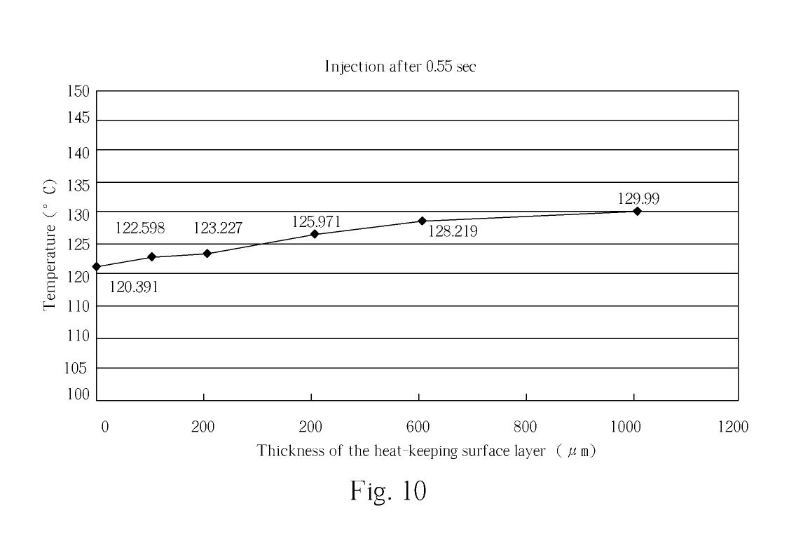

FIG. 9 is a graph illustrating the temperature distribution curve of the optical disk mold 40 at 0.24 seconds in accordance with the first preferred embodiment of the present invention, and FIG. 10 is a graph illustrating the temperature distribution curve of the optical disk mold 40 at 0.55 seconds in accordance with the first preferred embodiment of the present invention. The horizontal coordinate shows the thickness of the first heat-keeping surface layer 46 in the optical disk mold 40, and the vertical coordinate shows the contact temperature of the contact area between the molten plastic and the optical disk mold 40. As shown in FIG. 9 and FIG. 10, as the thickness of the first heat-keeping surface layer 46 increases, the contact temperature also increases. Increase of the contact temperature is especially excellent when the thickness of the first heat-keeping surface layer 46 is under 400 μm. On the other hand, when the thickness range of the first heat-keeping surface layer 46 exceeds 400 μm, the increase quantity in the contact temperature is inferior to that of the first heat-keeping surface layer 46 under 400 μm. Since the temperature does not increase as well for a relatively thicker first heat-keeping surface layer 46, and the temperature does not increase enough for a relatively thinner first heat-keeping surface layer 46, the thickness of the first heat-keeping surface layer 46 should be in a range from 100 μm to 800 μm, preferably 400 μm, for the above operating conditions of the present invention. Taking the current optical disk process for forming standard optical disks as an example, the contact temperature increases from the original 123.7° C. to 131.3° C. when the first heat-keeping surface layer 46 having a thickness of 400 μm is included in the optical disk mold 40. As known to those skilled in the art, the preferred thickness range of the first heat-keeping surface layer 46 can be adjusted according to factors, such as mold type, product design, properties of raw materials, and operating temperature.

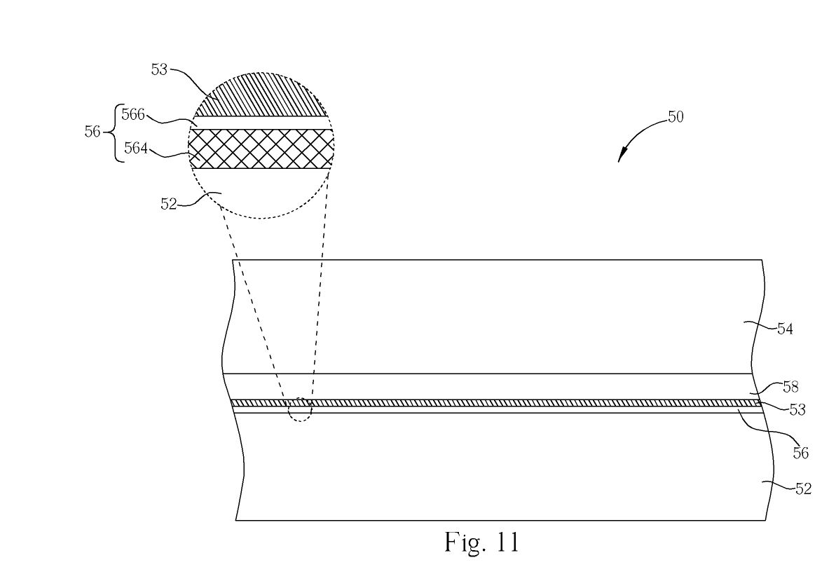

In addition, please refer to FIG. 11. FIG. 11 is a diagram illustrating an optical disk mold 50 having a heat-keeping surface layer 56 in accordance with the second preferred embodiment of the present invention. As shown in FIG. 11, the optical disk mold 50 includes a first mold plate 54, a second mold plate 52, a mold cavity 58, a first heat-keeping surface layer 56, and a stamper 53. In this embodiment, the first heat-keeping surface layer 56 mainly contains a heat-insulating coating layer 564 having a low heat-conducting coefficient, where the connecting coating layer, the first smooth coating layer, and the second smooth coating layer are optional components. For instance, the first heat-keeping surface layer 56 can include merely a heat-insulating coating layer 564 and a first smooth coating layer 566, omitting the connecting coating layer and the second smooth coating layer shown in the first preferred embodiment. The thickness of the heat-insulating coating layer 564 can be 100 μm to 1000 μm, preferably ranging from 100 μm to 400 μm. The first smooth coating layer 566 can be made from fine materials, such as tungsten carbide or aluminum silicide, and has a thickness of about 50 μm.

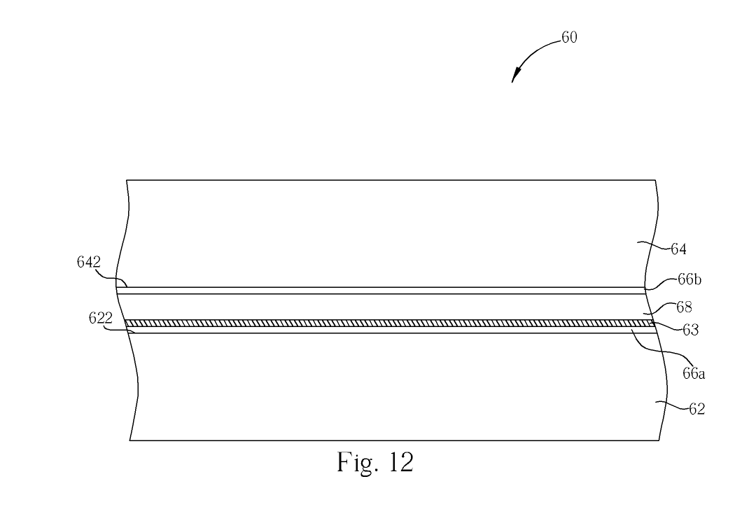

Furthermore, a second heat-keeping surface layer and a first heat-keeping surface layer can be formed respectively on the first mold plate and the second mold plate in the present invention. Please refer to FIG. 12. FIG. 12 is a diagram illustrating an optical disk mold 60 having two heat-keeping surface layers 66a and 66b in accordance with the third preferred embodiment of the present invention. The optical disk mold 60 shown in FIG. 12 has been simplified. As shown in FIG. 12, the optical disk mold 60 includes a first mold plate 64, a second mold plate 62, a mold cavity 68, a first heat-keeping surface layer 66a, a second heat-keeping surface layer 66b, and a stamper 63. The second mold plate 62 and the first mold plate 64 have a cleaned rough surface 622 and a cleaned rough surface 642, respectively, and the two rough surfaces 622 and 642 are adjacent to the mold cavity 68. Subsequently, the first heat-keeping surface layer 66a and the second heat-keeping surface layer 66b are formed on the rough surface 622 and the rough surface 642, respectively, by means of the hot-spraying processes disclosed in the above-mentioned embodiments. The first heat-keeping surface layer 66a and the second heat-keeping surface layer 66b are both made from heat-keeping materials having low heat-conducting coefficients, and range between 50 μm and 1000 μm in thickness.

Generally speaking, a hot-spraying process mainly contains four steps: raw material melt, particle acceleration, particle impact, and solidification. In the raw material melting step, solid raw material is melted into the liquid state by heating. Afterward, the particles are accelerated, so that the molten particles can impact the surface of the second mold plate. Accordingly, the molten particles can have flat shapes and adhere to the rough surface of the second mold plate. Next, the molten material solidifies and turns into a heat-keeping surface layer immediately. Depending on different heat sources utilized in the raw material melting step, the raw material melting process can be divided into plasma spraying treatments, high velocity oxy-fuel spraying treatments, combustion flam spraying treatments, and arc spraying treatments. Each of the said spraying treatments, or a combination of the above-mentioned spraying treatments, can be adopted as a hot-spraying process in the present invention. For example, the plasma spraying treatment, the high velocity oxy-fuel spraying treatment, and the combustion flam spraying treatment are appropriate for handling powdery raw materials, while the arc spraying treatment would be inappropriate. In addition, the plasma spraying treatment and the high velocity oxy-fuel spraying treatment are rather unsuited to handling linear raw materials.

The present invention simplifies the process of forming the heat-keeping surface layer, and makes the structure of the produced optical disk mold firmer and more stable, because the heat-keeping surface layer is formed by the hot-spraying process. If the heat-keeping surface layer is formed by an electroplating process, only an extremely thin coating layer can be coated on the surface of the target, and a heat-keeping surface layer having the preferred thickness cannot be fabricated easily. On the other hand, if a heat-insulating object is applied by means of insertion, the process of forming the heat-insulating object will be over-complicated. Moreover, the structure of the heat-insulating object installed by insertion is not as firm as the structure of the heat-keeping surface layer fabricated by the hot-spraying process. As a result, the temperature adjusting ability and the mold operating efficiency of the heat-insulating insert less impressive than the heat-keeping surface layer fabricated by the hot-spraying process.

Briefly speaking, because the optical disk mold of the present invention mainly contains a heat-keeping surface layer, which is formed by a hot-spraying process and has a low heat-conducting coefficient, the heat-keeping surface layer can retain the heat briefly when the molten plastic is just injected. Thus, the heat-keeping surface layer can indeed increase the contact temperature of the interface of the molten plastic and the optical disk mold. Accordingly, no residual stress exists in the border of the molten plastic adjacent to the optical disk mold, and the pattern-transferring ability of the optical disk mold is improved. On the other hand, since the temperature of the molten plastic decreases steadily and quickly after the mold cavity is filled, the present invention meets the injection requirement, “Inject at a high temperature, and cool at a low temperature”. It not only shortens the cycle time of producing the optical disk, but also increases the tensile strength of products, the photoelastic property, and the appearance of the welding line.

Those skilled in the art will readily observe that numerous modifications and alterations of the device and method may be made while retaining the teachings of the invention.

What is claimed is:

1. An optical disk mold, comprising:
a first mold plate;
a second mold plate positioned corresponding to the first mold plate, forming a mold cavity disposed between the first mold plate and the second mold plate, comprising a first heat-keeping surface layer disposed on a surface of the second mold plate in the mold cavity; and
a stamper positioned between the first mold plate and the first heat-keeping surface layer, and having a microstructure pattern positioned on a surface of the stamper.

2. The optical disk mold of claim 1, wherein the mold cavity is disk-shaped.

3. The optical disk mold of claim 1, wherein the first heat-keeping surface layer comprises a ceramic material.

4. The optical disk mold of claim 1, wherein the first heat-keeping surface layer comprises aluminum oxide, zirconium oxide, or yttrium oxide.

5. The optical disk mold of claim 1, wherein the first heat-keeping surface layer comprises a connecting coating layer, a heat-insulating coating layer, a first smooth coating layer, and a second smooth coating layer.

6. The optical disk mold of claim 5, wherein the heat-insulating coating layer is positioned on the connecting coating layer, the first smooth coating layer is positioned on the heat-insulating coating layer, and the second smooth coating layer is positioned on the first smooth coating layer.

7. The optical disk mold of claim 5, wherein the connecting coating layer comprises a metal material or a ceramic material.

8. The optical disk mold of claim 5, wherein the heat-insulating coating layer comprises a ceramic material.

9. The optical disk mold of claim 5, wherein the first smooth coating layer comprises tungsten carbide.

10. The optical disk mold of claim 5, wherein the second smooth coating layer comprises a diamond-like carbon coating or titanium nitride.

11. The optical disk mold of claim 1, wherein the first mold plate comprises a second heat-keeping surface layer on a surface of the first mold plate in the mold cavity.

12. A method of forming an optical disk mold, comprising:
providing a first mold plate and a second mold plate, the second mold plate having a mold cavity disposed between the first mold plate and the second mold plate, the mold cavity having a disk-shape; and
performing a first spraying process so as to dispose a first heat-keeping surface layer on a surface of the second mold plate in the mold cavity.

13. The method of claim 12, wherein the first spraying process comprises a plasma spraying treatment, a high velocity oxy-fuel spraying treatment, a combustion flam spraying treatment, or an arc spraying treatment.

14. The method of claim 12, wherein the first heat-keeping surface layer is formed on a rough surface of the second mold plate.

15. The method of claim 12, further comprising a step of performing a polishing process on the first heat-keeping surface layer.

16. The method of claim 12, further comprising a step of providing a stamper after the step of performing the first spraying process.

17. The method of claim 16, wherein the stamper is positioned between the first mold plate and the first heat-keeping surface layer, and comprises a microstructure pattern on a surface of the stamper.

18. The method of claim 12, wherein the first heat-keeping surface layer comprises a ceramic material.

19. The method of claim 12, wherein the first heat-keeping surface layer comprises a connecting coating layer, a heat-insulating coating layer, and a first smooth coating layer.

20. The method of claim 19, wherein the heat-insulating coating layer is formed on the connecting coating layer, and the first smooth coating layer is formed on the heat-insulating coating layer.

21. The method of claim 19, wherein the connecting coating layer comprises a metal material or a ceramic material.

22. The method of claim 19, wherein the heat-insulating coating layer comprises a ceramic material.

23. The method of claim 19, wherein the first smooth coating layer comprises tungsten carbide.

24. The method of claim 19, further comprising a step of performing a polishing process on the first smooth coating layer.

25. The method of claim 19, further comprising a step of performing a chemical vapor deposition process to form a second smooth coating layer on a surface of the first smooth coating layer.

26. The method of claim 25, wherein the second smooth coating layer comprises a diamond-like carbon coating or titanium nitride.

27. The method of claim 12, further comprising performing a second spraying process to form a second heat-keeping surface layer on a surface of the first mold plate in the mold cavity.
